(19) United States
(12) Patent Application Publication
(10) Pub. No.: US 2019/0168350 A1
(43) Pub. Date: Jun. 6, 2019

(54) DEVICE FOR MACHINING ROD-SHAPED WORKPIECES SUCH AS WINDOW PROFILES OR DOOR PROFILES

(71) Applicant: SCHIRMER MASCHINEN GMBH, 33415 Verl (DE)

(72) Inventors: Roland VOGT, Verl (DE); Andeas HEEKE, Verl (DE)

(73) Assignee: SCHIRMER MASCHINEN GMBH, 33415 Verl (DE)

(21) Appl. No.: 16/092,479

(22) PCT Filed: Apr. 25, 2017
(86) PCT No.: PCT/EP2017/059734

§ 371 Date: Oct. 10, 2018

(30) Foreign Application Priority Data
Apr. 29, 2016 (EP) 16167809.9

(51) Int. Cl. B23Q 39/02; B27C 9/04; B27M 1/08

(52) U.S. Cl. CPC B23Q 39/026; B27C 9/04; B23Q 2240/007; B23Q 2210/006; B27M 1/08

(57) ABSTRACT

A device is provided for machining rod-shaped workpieces such as window profiles or door profiles which can be moved on at least one horizontal plane by means of a transport device. A machining device with tools is provided on a plane that is substantially perpendicular to the movement direction of the workpieces, the machining device being spatially aligned with the workpiece on the perpendicular plane. The machining device includes partial circle segments which are arranged on perpendicular planes that can be adjusted relative to one another and on the partial circle arc of which the tools are arranged in a movable manner. Each of the individual partial circle segments can be moved in the X, Y, and Z direction.

### BACKGROUND AND SUMMARY

The invention relates to a device for machining rod-shaped workpieces such as window profiles or door profiles, which are movable by means of a transportation device in at least one horizontal plane and wherein a machining device having tools, which is spatially aligned in the perpendicular plane in relation to the workpiece, is provided in a plane arranged substantially perpendicularly to the movement direction of the workpieces.

Numerous different work procedures are to be carried out during the machining of profiles which are used for producing doors or windows. Such profiles can consist of or comprise plastic, metal, or wood. A combination of various materials is also possible. If, for example, plastic hollow profiles for windows are machined, drainage slots have to be milled diagonally into the rebate and/or on the bottom and/or in the front. Moreover, closing part position boreholes are to be placed on a fixed frame profile and/or on a transom profile. Furthermore, lock cases possibly have to be milled out. Center screws for roller blinds, guide rails, and rain guards also have to be installed. Furthermore, corner bracket boreholes are to be provided in the sash bearing cover fitting. Typical diameters for drainage and ventilation slots are, for example, 5 mm here, while the closing part boreholes and the corner bracket boreholes always have a diameter of 3 mm. To be able to produce these different boreholes and milled grooves, various machining tools are required, such as drills or milling cutters in different sizes.

In the case of automated machining, the possibility is lost of being able to exchange the drill bits, for example, in a single drill, because the effort for this purpose would be excessively large. It is simpler to provide drills each having different bits or different drilling and milling tools from the outset.

To address this machining expenditure and to provide automated machining as much as possible here, a device for machining components is known from DE 197 25 043 A1. The known device has for this purpose a machining device, having its machining units which are spatially aligned in relation to the workpiece, extending in the plane arranged substantially perpendicular to the movement direction of the components. The machining tools are located for this purpose on a carrier element, and therefore the machining tools provided on the carrier element appropriately begin machining by movement of the yoke-like carrier element in relation to the workpiece provided in the transportation direction.

In this known embodiment, it is considered to be disadvantageous that the machining tools provided on the carrier element are still in need of substantial improvement with respect to the flexible machining on the workpiece and also with respect to the machining speed on the workpiece.

It is desirable to refine a device for machining rod-shaped workpieces of the type, which ensures a higher level of processing reliability with respect to the machining of the workpiece while providing a careful surface treatment, on the one hand, wherein in particular the machining time of the workpiece is also to be substantially shortened. Moreover, it is desirable to make the machining access of the machining tool to the workpiece on the transportation device substantially more flexible.

The advantages achieved by aspects of the invention are that using the device according to the invention for machining, the access directions of the machining tools in the perpendicular plane in relation to the transported workpiece are made substantially more flexible, since the machining tools are arranged so they are movable on two partial circle paths in relation to the workpiece to be transported. The high level of flexibility and the reduction of the machining time is substantially achieved in that the two partial circle segments on which the machining tools are provided can be moved independently of one another, and therefore parallel machining can take place on both sides of the workpiece. For this purpose, the machining device consists of or comprises partial circle segments arranged adjustably in relation to one another, on the partial circle arcs of which the tools are movable. The individual partial circle segments are each movable independently of one another in the X, Y, and Z directions in the device framework. The possibility therefore exists that the milling or drilling tool can engage on the workpiece at an angle to the workpiece and in different angular positions here. In this case, because of the two partial circle segments movable independently of one another in the spatial position, the possibility now exists that the machining can take place on both sides at different engagement points on the workpiece, and therefore the machining time on a workpiece is thus halved.

In a refinement of an aspect of the invention, it is particularly advantageous that the one partial circle segment is arranged on a movable column and wherein the other partial circle segment is movably arranged on a gantry. The partial circle segments complete one another in this case to form a circular ring, wherein the individual partial circle segments are each arranged adjacent to the transportation device for the rod-shaped workpiece. Because of the design that the one partial circle segment is provided on a column, wherein the other partial circle segment is arranged on a gantry, the possibility now exists that the two partial circle segments can act on the workpiece and/or the transportation device here while pivoted by an angle amount. The partial circle segment arranged on the gantry thus overlaps the transportation device by a radian measure from above, wherein the partial circle segment arranged on the column engages below the transportation device by a radian measure from below. For the mobility of the tools on the partial circle segments, this therefore has the result that these tools can be moved up beyond the transportation device, and therefore machining of the workpiece from above is ensured. This correspondingly also results for the other partial circle segment, which engages under the workpiece from below. The partial circle segment arranged on the gantry is thus advantageously arranged on a circular arc dimension section which extends between the circle angles of approximately 135° to 315°, wherein the partial circle segment correspondingly arranged opposite on the column is arranged in completion of the circular ring, i.e., from 315° to 135°. It is also conceivable that the partial circle segments can be positioned on circular arc sections of 20° to 200° and correspondingly of 200° to 20°.

According to one advantageous embodiment of the invention, a movable carriage is provided on each of the partial circle segments, on which a motor and the machining tools are arranged. To move the tools on the partial circle segments, a toothed belt is tensioned on the external lateral arc of the respective partial circle segment, which cooperates with a gearwheel arranged on a motor axis. Providing other means for the formfitting connection are also conceivable for this purpose, for example, a curved toothed rack in order to move the carriage along the path.

The motor is designed in this case as a servomotor, and therefore it can be actuated for forward or reverse running, in order to provide the movement of the carriage and thus the machining tools on the partial circle segment in this manner. The motor axis is aligned with the gearwheel perpendicular to the partial circle segment, wherein contact pressure rollers are mounted on the carriage for the toothed rack belt in each case in front of and behind the gearwheel. As a result of this design, the flexibly held toothed rack belt is guided and held by positive guiding via the gearwheel on the motor axis. This is only one example of a type of drive which can be used for the partial circle movement path.

In a refinement, the tools designed as milling cutters or drills are arranged on the carriage, wherein the tools are movably and/or displaceably arranged on the carriage. As a result of the control thereof, they can be moved accordingly in relation to the workpiece to execute their work steps there, wherein they can thus be moved on a fourth axis in relation to the X, Y, and Z axes, which are specified by the column or the gantry.

### BRIEF DESCRIPTION OF THE DRAWINGS

An exemplary embodiment of the invention is illustrated solely schematically in the drawings and will be described in greater detail hereafter. In the figures:

FIG. 1 shows a perspective illustration of the machining device according to the invention,

FIG. 2 shows a side view of the machining device according to FIG. 1,

FIG. 3 shows a perspective illustration of the drive for the movable carriage, and

FIG. 4 shows a further illustration of the drive for the carriage in a further illustration.

### DETAILED DESCRIPTION

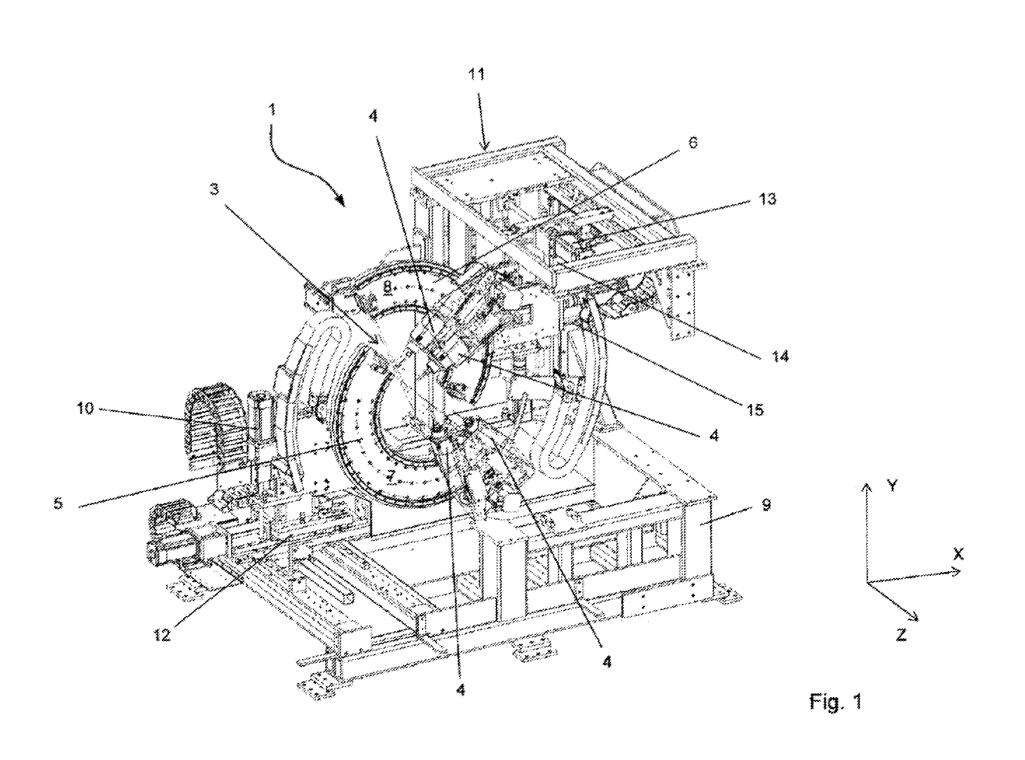

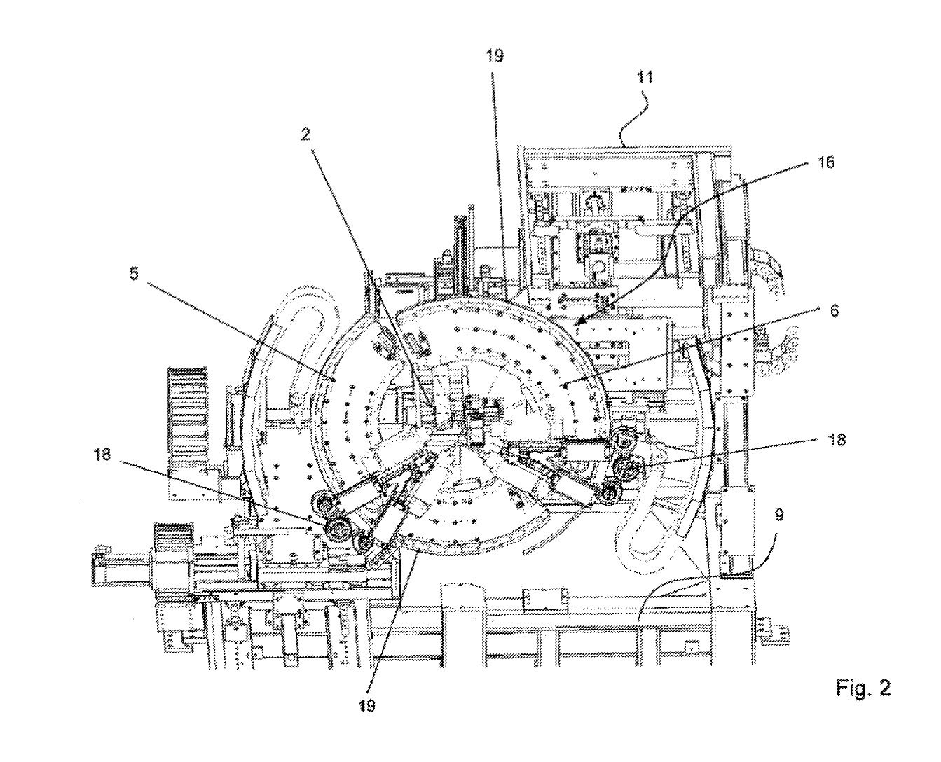

FIG. 1 shows a device 1 for machining rod-shaped workpieces, for example, window profiles or door profiles (not shown in greater detail), which are movable by means of a transportation device 2 in at least one horizontal plane, the Z plane here according to the coordinate cross. The transportation device 2 can be seen better here in FIG. 2, where it is shown in the center of the device 1. The transportation device 2 can be movably arranged in a horizontal plane for this purpose, and therefore the rod-shaped workpieces arranged on the transportation device 2 can be guided through and/or moved through the machining device 1. Other transportation devices are also conceivable, for example, transportation jaws, which are not shown in greater detail here. The plane of the transportation device corresponds here to the movement direction in the Z direction, as is identified in greater detail in the coordinate system in FIG. 1.

In a plane arranged substantially perpendicularly to the movement direction of the workpieces on the transportation device 2, the Y plane here, a machining device 3 having tools 4 is provided, which is spatially aligned in the perpendicular plane Y in relation to the workpiece. As can be seen clearly in particular from FIG. 1 and FIG. 2, the machining device 3 consists of or comprises partial circle segments 5 and 6, which are adjustable in relation to one another and are arranged on planes, and on the partial circle arcs 7 and 8 of which the tools 4 are movably arranged. The individual partial circle segments 5 and 6 are each movable on a framework 9 of the device 1 for this purpose in each case in the X, Y, and Z directions. In this case, the one partial circle segment 5 is arranged on a movable column 10 and the other partial circle segment 6 is arranged movably on a gantry 11. The partial circle segment 5 on the column 10 is movable up or down in each case in the Y direction in this case, wherein it can be moved in the X direction on or with the column 10 on a carriage 12. The carriage 12 in turn can be moved on the framework 9 of the device 1 in the Z direction according to the arrow.

The partial circle segment 6 mounted and supported in the gantry 11 is also moved in all three axes, wherein the Z axis can be seen as the upper carriage 13 in the upper region of the portal 11. A downwardly oriented column 14, on which the partial circle segment 6 can be moved upward and downward, i.e., in the Y direction, is provided on the carriage 13. A corresponding horizontally movable axis in the X direction is accordingly provided on the column 14 facing downward, and therefore the partial circle segment 6 can be moved accordingly toward the center or away from the center.

As can be seen from FIG. 2 in particular, the partial circle segments 5 and 6 are each arranged adjacent to the transportation device 2 for the rod-shaped workpiece to complete a circular ring 16. As can furthermore be clearly seen from FIG. 2, the partial circle segment 6 arranged on the gantry 11 is arranged on a circular arc section, which extends between the circle angles of approximately 135° to 315°, wherein accordingly the partial circle segment 5 arranged on the column 10 is arranged opposite in completion of the circular ring 16. Because of this design, it is possible that the tools 4 arranged on the partial circle segments 5 and 6 can each be moved over the workpiece to be machined in one case from above and accordingly also can be moved under the workpiece from below. The tools 4 on the partial circle segment 6, which is provided on the gantry 11, can therefore move here beyond the 0°/360° position. This accordingly also applies for the lower partial circle, where the tools 4 can be moved here beyond a 180° position.

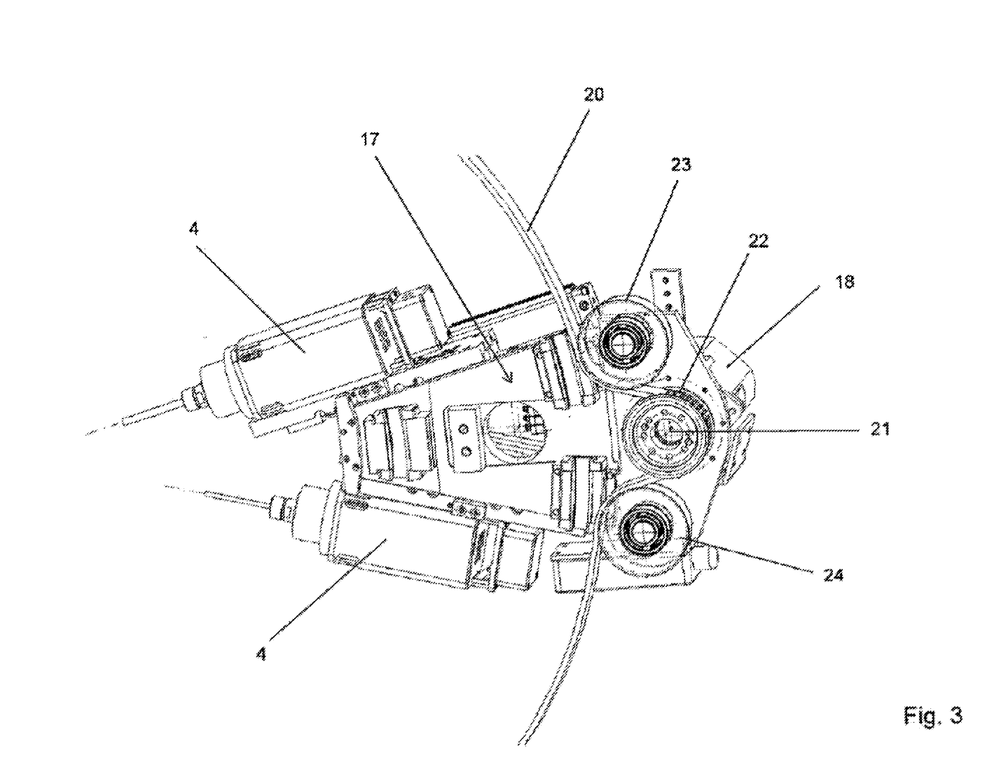

As is recognizable from each of FIGS. 1, 2, 3, and 4, a movable carriage 17, on which a motor 18 and the tools 4 is arranged, is arranged on each of the partial circle segments 5, 6. As can be seen clearly in particular from FIG. 3, a toothed belt 20, which interacts with a gearwheel 22 arranged on the motor axis 21, is tensioned in each case on the outer lateral arc 19 of the partial circle segments 5, 6. The motor axis 21 is arranged in this case parallel to the partial circle segments 5, 6, with the gearwheel 22 perpendicular. As can be seen clearly from FIG. 3, contact pressure rollers 23 and 24 are mounted on the carriage 17 for the toothed belt 20 in each case in front of and behind the gearwheel 22. As a result of this arrangement, a positive guide of the toothed belt 20 results via the gearwheel 22 such that as it runs on, targeted guiding takes place on the gearwheel 22, wherein as it runs off from the gearwheel 22, the toothed belt 20 rests on the lateral arc 19 of the partial circle segments 5, 6 again.

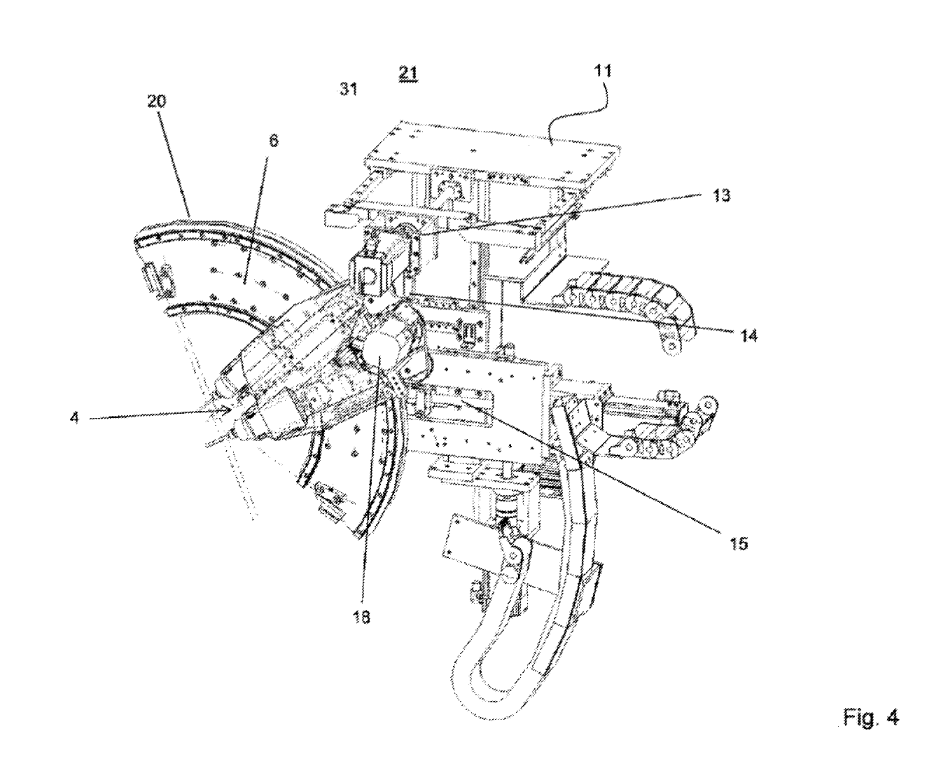

As can be seen in particular from FIGS. 3 and 4, the tools 4 designed as milling cutters or drills are arranged on the carriage 17. As can furthermore be seen, the tools 4 are movably and/or displaceably supported in relation to the center axis on the carriage 17 in this case.

A four-axis machining station therefore results for the degree of freedom of the individual tool 4, wherein the three axes of the spatial coordinate system come to bear at once here, as a result of the mounting of the individual partial circle segments 5, 6, whether it is on the column 10 or on the portal 11, wherein the fourth axis is enabled in different positions in relation to the workpiece and in particular here in different angular positions in relation to the workpiece by the movement and/or the displacement of the tool 4 on the partial circle segment 5, 6.

### LIST OF REFERENCE NUMERALS

01 device
02 transportation device
03 machining device
04 tools
05 partial circle segment
06 partial circle segment
07 partial circle arc
08 partial circle arc
09 framework
10 column
11 gantry
12 carriage
13 carriage
14 column oriented downward
15 horizontal axis
16 circular ring
17 tool carriage
18 motor
19 lateral arc
20 toothed belt
21 motor axis
22 gearwheel
23 contact pressure roller
24 contact pressure roller

1. A device for machining rod-shaped workpieces such as window profiles or door profiles, which are movable by means of a transportation device in at least one horizontal plane, and wherein a machining device having tools, which is spatially aligned in the perpendicular plane in relation to the workpiece, is provided in a plane arranged substantially perpendicularly to the movement direction of the workpieces,
wherein the machining device comprises partial circle segments and, which are arranged in adjustable planes perpendicular to one another, and on the partial circle arcs and of which the tools are movably arranged, and the individual partial circle segments, are each movable in the X, Y, and Z directions.

2. The device as claimed in claim 1,
that wherein one partial circle segment is arranged on a movable column and the other partial circle segment is movably arranged in a gantry.

3. The device as claimed in claim 1,
wherein the partial circle segments and are each arranged to complete a circular ring adjacent to the transportation device for the rod-shaped workpiece.

4. The device as claimed in claim 1,
wherein the partial circle segment arranged on the gantry is arranged on a circular arc dimension section which extends between the circle angles of approximately 135° to 315° or from 20° to 200°, wherein the partial circle segment arranged on the column is correspondingly arranged opposite in completion of the circular ring.

5. The device as claimed in claim 1,
wherein a movable carriage, on which a motor and the machining tools are arranged, is arranged on each of the partial circle segments.

6. The device as claimed in claim 1,
wherein means for formfitting with the motor are provided on the outer lateral arc (19) of the partial circle segments.

7. The device as claimed in claim 1,
wherein a toothed belt (20), which interacts with a gearwheel arranged on a motor axis, is preferably arranged on each of the outer lateral arcs (19).

8. The device as claimed in claim 1,
wherein the motor axis is arranged having the gearwheel perpendicular to the partial circular segment.

9. The device as claimed in claim 1,
wherein contact pressure rollers and are supported on the carriage for the toothed belt (20) respectively in front of and behind the gearwheel.

10. The device as claimed in claim 1,
wherein the tools designed as milling cutters or drills are arranged on the carriage.

11. The device as claimed in claim 1,
wherein the tools are movable or displaceable on the carriage in relation to the center axis.
